(19) United States
(12) Patent Application Publication
(10) Pub. No.: US 2026/0291131 A1
(43) Pub. Date: Sep. 24, 2026

(54) Signal Terminal Module, Connector Module and Connector

(71) Applicants: Tyco Electronics Holdings (Bermuda) No. 7 Limited, Hamilton (BM); Tyco Electronics (Shanghai) Co., Ltd., Shanghai (CN)

(72) Inventors: Ava Hsu, Taipei (TW); Yang(Eric) Shi, Shanghai (CN); Guangming (Suny) Zhao, Shanghai (CN); Kuo-Wei Chang, Taipei (TW)

(73) Assignees: Tyco Electronics Holdings (Bermuda) No. 7 Limited, Hamilton (BM); Tyco Electronics (Shanghai) Co., Ltd., Shanghai (CN)

(21) Appl. No.: 19/571,746

(22) Filed: Mar. 19, 2026

(30) Foreign Application Priority Data
Mar. 19, 2025 (CN) 202510326950.1

(51) Int. Cl. H01R 13/6474; H01R 12/73; H01R 13/03; H01R 13/24; H01R 13/405; H01R 13/50; H01R 13/6471

(52) U.S. Cl. CPC H01R 13/6474; H01R 12/73; H01R 13/03; H01R 13/245; H01R 13/405; H01R 13/50; H01R 13/6471

(57) ABSTRACT

A signal terminal module includes a signal terminal and a conductive sheet. The signal terminal has a first fixing part and a first elastic arm connected to the first fixing part. The first elastic arm includes a first electrical contact part located at its end for electrical contact with a mating electrical board card. The conductive sheet is attached to the first elastic arm of the signal terminal and adjusts a contact impedance of the first electrical contact part of the signal terminal.

### CROSS-REFERENCE TO RELATED APPLICATION

This application claims the benefit of Chinese Patent Application No. CN202510326950.1 filed on Mar. 19, 2025 in the State Intellectual Property Office of China, the whole disclosure of which is incorporated herein by reference.

### FIELD OF THE INVENTION

The present invention relates to a signal terminal module, a connector module comprising the signal terminal module, a connector comprising the signal terminal module, and a connector comprising the connector module.

### BACKGROUND OF THE INVENTION

In the prior art, high-speed connectors often have the characteristics of small size, low power consumption, and high signal transmission rate. In some applications, the signal transmission rate of high-speed connectors needs to reach 112 Gbit/s, 224 Gbit/s, or higher. Impedance matching is an important performance characteristic of high-speed connectors, and it is usually desirable for the impedance at all positions of the high-speed connector to remain constant, that is, equal to the designed nominal impedance. However, the elastic arm of the high-speed connector undergoes elastic deformation, resulting in changes in the contact impedance of the electrical contacts on the elastic arm. When the change value is too large, it can cause the contact impedance of the electrical contacts to deviate from the nominal impedance, leading to impedance mismatch and affecting the signal integrity of the signal transmission path.

### SUMMARY OF THE INVENTION

A signal terminal module includes a signal terminal and a conductive sheet. The signal terminal has a first fixing part and a first elastic arm connected to the first fixing part. The first elastic arm includes a first electrical contact part located at its end for electrical contact with a mating electrical board card. The conductive sheet is attached to the first elastic arm of the signal terminal and adjusts a contact impedance of the first electrical contact part of the signal terminal.

### BRIEF DESCRIPTION OF DRAWINGS

Features of the present invention will become more apparent by describing in detail exemplary embodiments thereof with reference to the accompanying drawings, in which:

FIG. 1 shows an illustrative perspective view of a connector module according to an exemplary embodiment of the present invention;

FIG. 2 shows a row of terminals of a connector module according to an exemplary embodiment of the present invention;

FIG. 3 shows an illustrative perspective view of a pair of signal terminal modules according to an exemplary embodiment of the present invention;

FIG. 4 shows an illustrative exploded view of a pair of signal terminal modules according to an exemplary embodiment of the present invention;

FIG. 5 shows an illustrative view of electrical contact between a pair of signal terminal modules and a mating electrical board card according to an exemplary embodiment of the present invention;

FIG. 6 shows an impedance curve diagram according to an exemplary embodiment of the present invention; and

FIG. 7 shows the return loss curve of an exemplary embodiment according to the present invention.

The features disclosed in this disclosure will become more apparent in the following detailed description in conjunction with the accompanying drawings, where similar reference numerals identify corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

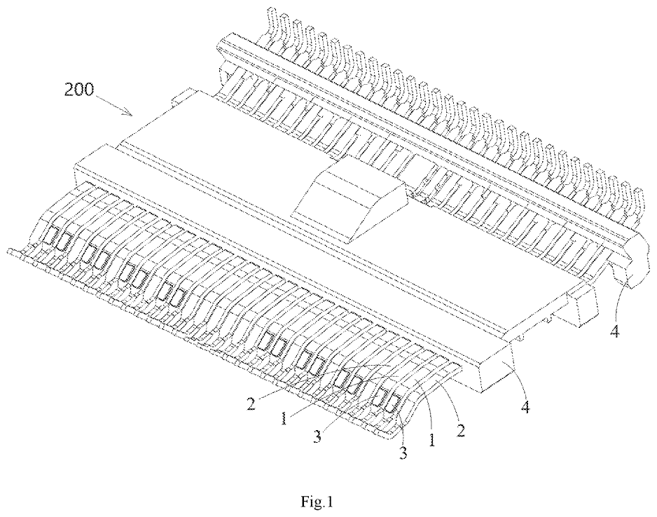

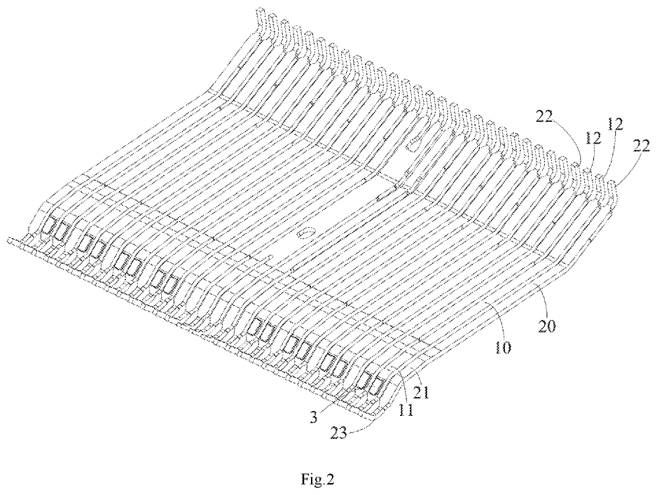

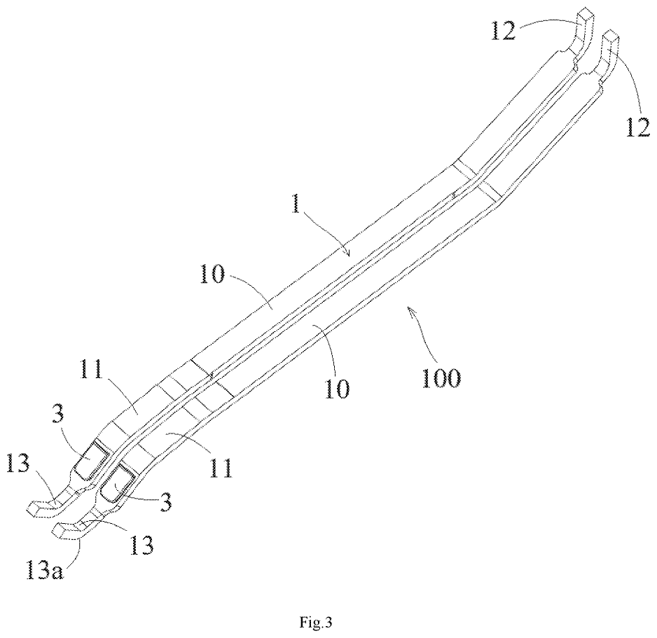

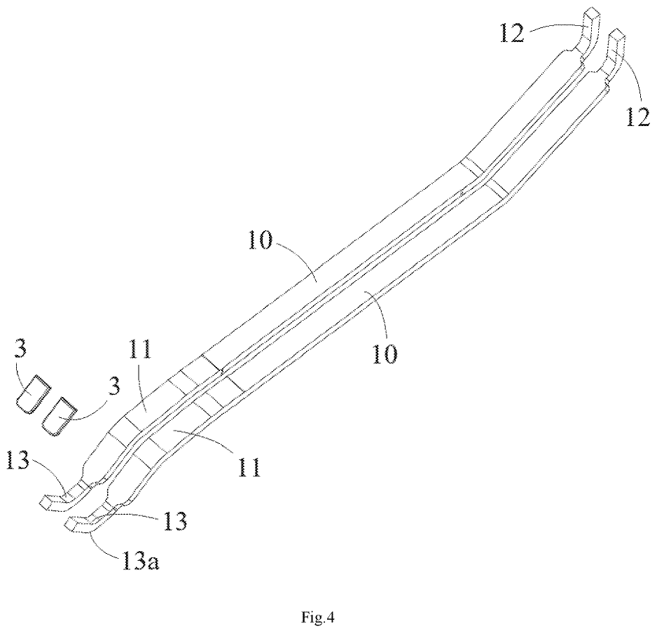

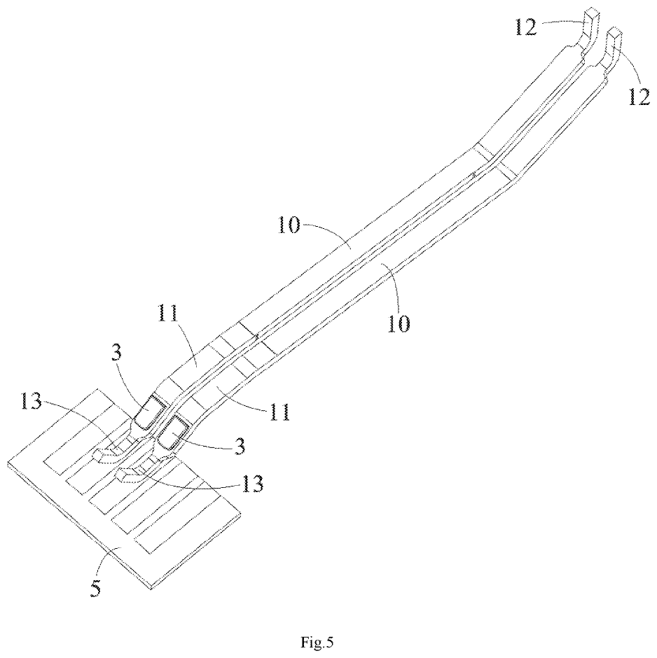

FIG. 1 shows an illustrative perspective view of a connector module 200 according to an exemplary embodiment of the present invention; FIG. 2 shows a row of terminals of a connector module 200 according to an exemplary embodiment of the present invention; FIG. 3 shows an illustrative perspective view of a pair of signal terminal modules 100 according to an exemplary embodiment of the present invention; FIG. 4 shows an illustrative exploded view of a pair of signal terminal modules 100 according to an exemplary embodiment of the present invention; FIG. 5 shows an illustrative view of electrical contacts between a pair of signal terminal modules 100 and a mating electrical board card 5 according to an exemplary embodiment of the present invention.

As shown in FIGS. 1 to 5, in an exemplary embodiment of the present invention, a signal terminal module 100 is disclosed. The signal terminal module 100 includes: a signal terminal 1 and a conductive sheet 3. The signal terminal 1 has a first fixing part 10 and a first elastic arm 11 connected to the first fixing part 10. The conductive sheet 3 is attached to the first elastic arm 11 of signal terminal 1. The first elastic arm 11 has a first electrical contact part 13 located at its end for electrical contact with a mating electrical board card 5. The conductive sheet 3 is used to adjust the contact impedance of the first electrical contact part 13 of the signal terminal 1, so that the contact impedance of the first electrical contact part 13 of the first elastic arm 11 can be equal to or approximately equal to the designed nominal impedance, thereby improving the signal integrity of the signal transmission path.

As shown in FIGS. 1 to 5, in the illustrated embodiment, the conductive sheet 3 is attached to the first elastic arm 11 of the signal terminal 1 near the first electrical contact part 13.

As shown in FIG. 3, in the illustrated embodiment, the first electrical contact part 13 has an electrical contact surface 13a for electrical contact with the mating electrical board card 5, and the conductive sheet 3 is attached to the side of the first elastic arm 11 of the signal terminal 1 facing away from the electrical contact surface 13a. However, the present invention is not limited to the illustrated embodiment. For example, the first elastic arm 11 has opposite front and back surfaces in its thickness, and the conductive sheet 3 can be attached to the front or back surface of the first elastic arm 11 of the signal terminal 1.

In the illustrated embodiment, only one conductive strip 3 is attached to each signal terminal 1. However, the present invention is not limited to the illustrated embodiments. For example, the signal terminal module 100 may include multiple conductive sheets 3, which are respectively attached to the front and/or back of the first elastic arm 11 of the signal terminal 1.

In an embodiment, the conductive sheet 3 can be soldered or crimped onto the first elastic arm 11 of the signal terminal 1, as long as it is ensured that the conductive sheet 3 can be electrically connected to the first elastic arm 11 of the signal terminal 1.

As shown in FIGS. 1 to 5, in the illustrated embodiment, the first elastic arm 11 of signal terminal 1 is bent into a predetermined shape, and the first electrical contact part 13 of signal terminal 1 is bent into an arc shape.

In an embodiment, the conductive sheet 3 and the signal terminal 1 can be made of the same conductive material or different conductive materials. For example, the signal terminal 1 can be made of copper or copper alloy. The conductive sheet 3 can be made of copper, copper alloy, silver, or silver alloy.

As shown in FIGS. 2 to 5, in the illustrated embodiment, the signal terminal 1 also has a first soldering pin 12, and the first elastic arm 11 and the first soldering pin 12 are respectively connected to both ends of the first fixing part 10.

In the illustrated embodiment, the signal terminal 1 is an integral stamped terminal. This can reduce manufacturing costs and improve manufacturing efficiency.

In an embodiment, the signal terminal 1 can be differential signal terminal 1 used for transmitting differential signals.

As shown in FIG. 1, in another exemplary embodiment of the present invention, a connector module 200 is also disclosed. The connector module 200 includes at least one pair of signal terminal modules 100 and a holding body 4. The holding body 4 is injection molded onto the first fixing parts 10 of at least one pair of signal terminals 1, so that the at least one pair of signal terminals 1 and the holding body 4 become an integrated piece.

As shown in FIGS. 1 and 2, in the illustrated embodiment, the connector module 200 further includes multiple ground terminals 2, each ground terminal 2 having a second fixing part 20 and a second elastic arm 21 connected to the second fixing part 20. The second elastic arm 21 has a second electrical contact part 23 located at its end for electrical contact with the mating electrical board card 5, and the holding body 4 is also injection molded onto the second fixing parts 20 of the multiple grounding terminals 2, so that at least one pair of signal terminals 1, multiple grounding terminals 2, and the holding body 4 are integrated into one piece.

As shown in FIGS. 1 to 3, in the illustrated embodiment, the connector module 200 includes multiple pairs of signal terminal modules 100. The multiple pairs of signal terminals 1 and multiple grounding terminals 2 of the connector module 200 are arranged in a row, and any pair of signal terminals 1 is set between two grounding terminals 2. The first elastic arms 11 of multiple pairs of signal terminals 1 and the second elastic arms 21 of multiple grounding terminals 2 extend from the front side of the holding body 4 for electrical contact with the mating electrical board card 5.

As shown in FIG. 2, in the illustrated embodiment, the grounding terminal 2 also has a second soldering pin 22, and the second soldering pin 22 and the second elastic arm 21 are respectively connected to both ends of the second fixing part 20. The first soldering pins 12 of multiple pairs of signal terminals 1 and the second soldering pins 22 of multiple grounding terminals 2 extend from the rear side of the holding body 4 for soldering to a circuit board.

As shown in FIGS. 1 and 2, in the illustrated embodiment, multiple conductive sheets 3 are respectively connected to the first elastic arms 11 of multiple signal terminals 1, and there is no electrical connection between the multiple conductive sheets 3. That is to say, multiple conductive sheets 3 are separated from each other.

In the illustrated embodiment, the signal terminal 1 is a differential signal terminal used for transmitting differential signals, and the differential signal terminals in connector module 200 are configured in pairs.

In another exemplary embodiment of the present invention, a connector is also disclosed. The connector comprises a housing and at least one pair of signal terminal modules 100. At least one pair of signal terminal modules 100 is installed into the housing. In another exemplary embodiment of the present invention, a connector is also disclosed. The connector comprises a housing and at least one of the aforementioned connector modules 200. The connector module 200 is installed into the housing.

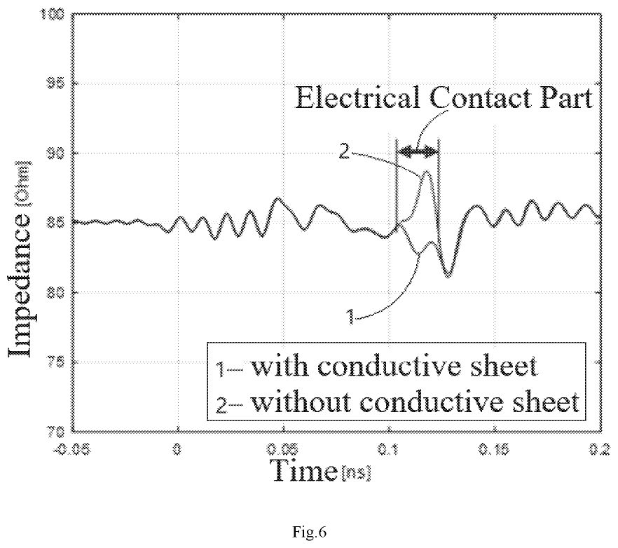

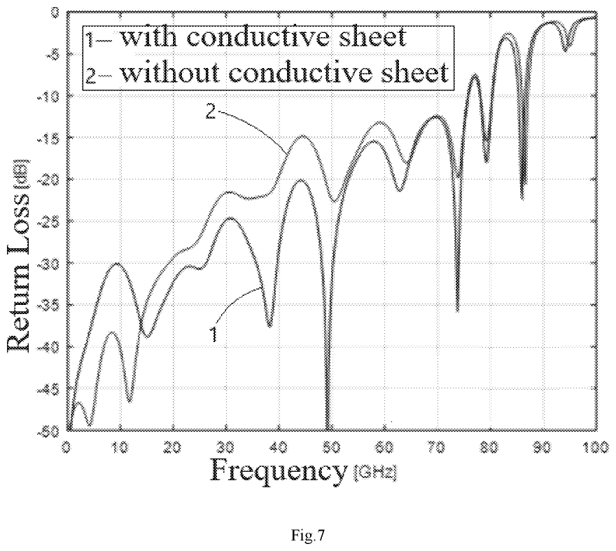

As determined through experimental testing, the signal transmission integrity of the signal terminal 1 with added conductive sheet 3 is significantly better than that of the signal terminal without the conductive sheet. FIG. 6 shows an impedance curve diagram according to an exemplary embodiment of the present invention; FIG. 7 shows the return loss curve of an exemplary embodiment according to the present invention.

As shown in FIG. 6, it is not possible to obtain good impedance results for the signal terminal without adding the conductive sheet 3. Severe impedance mismatch occurs in the time slot of 0.1 ns to 0.125 ns, with a peak impedance of around 89 ohms. The impedance of the signal terminal with added conductive sheet 3 is significantly decreased during the time slot from 0.1 ns to 0.125 ns without impedance mismatch.

As shown in FIG. 7, in the illustrated embodiment, the return loss of the signal terminal with added conductive sheet 3 before 65 GHz is significantly better than that without added conductive sheet 3.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A signal terminal module, comprising:
a signal terminal having a first fixing part and a first elastic arm connected to the first fixing part, the first elastic arm includes a first electrical contact part located at its end for electrical contact with a mating electrical board card; and
a conductive sheet attached to the first elastic arm of the signal terminal, the conductive sheet adjusts a contact impedance of the first electrical contact part of the signal terminal.

2. The signal terminal module according to claim 1, wherein the conductive sheet is attached to a location on the first elastic arm of the signal terminal proximate the first electrical contact part.

3. The signal terminal module according to claim 2, wherein the first elastic arm has opposite front and back surfaces in a thickness of the first elastic arm, and the conductive sheet is attached to the front or back surface of the first elastic arm of the signal terminal.

4. The signal terminal module according to claim 3, wherein the signal terminal module has a plurality of conductive pieces, which are respectively attached to the front and/or back of the first elastic arm of the signal terminal.

5. The signal terminal module according to claim 2, wherein the first electrical contact part has an electrical contact surface for electrical contact with the mating electrical board card, and the conductive sheet is attached to a side of the first elastic arm of the signal terminal facing away from the electrical contact surface.

6. The signal terminal module according to claim 1, wherein the conductive sheet is welded or crimped onto the first elastic arm of the signal terminal.

7. The signal terminal module according to claim 1, wherein the first elastic arm of the signal terminal is bent into a predetermined shape, and the first electrical contact part of the signal terminal is bent into an arc shape.

8. The signal terminal module according to claim 1, wherein the conductive sheet and the signal terminal are made of the same conductive material or different conductive materials.

9. The signal terminal module according to claim 1, wherein the signal terminal is made of copper or copper alloy, and the conductive sheet is made of copper, copper alloy, silver, or silver alloy.

10. The signal terminal module according to claim 1, wherein the signal terminal also has a first soldering pin, and the first elastic arm and the first soldering pin are respectively connected to both ends of the first fixing part.

11. The signal terminal module according to claim 10, wherein the signal terminal is an integral stamped terminal.

12. The signal terminal module according to claim 1, wherein the signal terminal is a differential signal terminal used for transmitting differential signals.

13. A connector module, comprising:
at least one pair of signal terminal modules, each comprising:
a signal terminal having a first fixing part and a first elastic arm connected to the first fixing part, the first elastic arm includes a first electrical contact part located at its end for electrical contact with a mating electrical board card; and
a conductive sheet attached to the first elastic arm of the signal terminal, the conductive sheet adjusts a contact impedance of the first electrical contact part of the signal terminal; and
a holding body injection molded onto the first fixing parts of at least one pair of signal terminals, so that the at least one pair of signal terminals and the holding body become an integrated piece.

14. The connector module according to claim 13, further comprising a plurality of grounding terminals, each grounding terminal having a second fixing part and a second elastic arm connected to the second fixing part, wherein the second elastic arm has a second electrical contact part located at its end for electrical contact with a mating electrical board card, and the holding body is also injection molded onto the second fixing parts of the multiple grounding terminals, so that the at least one pair of signal terminals, the multiple grounding terminals, and the holding body are integrated into one piece.

15. The connector module according to claim 14, wherein:
the connector module comprises multiple pairs of signal terminal modules, wherein the multiple pairs of signal terminals and multiple grounding terminals of the connector module are arranged in a row, and any pair of signal terminals is set between two grounding terminals; and
the first elastic arms of the multiple pairs of signal terminals and the second elastic arms of the multiple grounding terminals extend from the front side of the holding body for electrical contact with the mating electrical board card.

16. The connector module according to claim 15, wherein:
the grounding terminal has a second soldering pin, and the second soldering pin and the second elastic arm are respectively connected to both ends of the second fixing part; and
the first soldering pins of the multiple pairs of signal terminals and the second soldering pins of the multiple grounding terminals extend from the rear side of the holding body for soldering to a circuit board.

17. The connector module according to claim 13, wherein the conductive sheet is one of a plurality of conductive sheets respectively connected to the first elastic arms of multiple signal terminals, and there is no electrical connection between the plurality of conductive sheets.

18. The connector module according to claim 13, wherein the signal terminal is a differential signal terminal used for transmitting differential signals, and the differential signal terminals in the connector module are configured in pairs.

19. The connector module according to claim 13, further comprising a housing arranged about the at least one pair of signal terminal modules and the holding body.

20. A connector, comprising:
a housing; and
at least one pair of signal terminal modules installed into the housing, the signal terminal modules comprising:
a signal terminal having a first fixing part and a first elastic arm connected to the first fixing part, the first elastic arm includes a first electrical contact part located at its end for electrical contact with a mating electrical board card; and
a conductive sheet attached to the first elastic arm of the signal terminal, the conductive sheet adjusts a contact impedance of the first electrical contact part of the signal terminal.
